(19) United States
(12) Patent Application Publication
(10) Pub. No.: US 2013/0206751 A1
(43) Pub. Date: Aug. 15, 2013

(54) HOLE HEATING AND SPOT HEATING VIA ROTATIONAL OR RECIPROCATING MAGNETIC HEATING

(71) Applicants: Stephen B. Fitch, Massillon, OH (US); William Stuehr, North Royalton, OH (US); John Gadus, Richfield, OH (US)

(72) Inventors: Stephen B. Fitch, Massillon, OH (US); William Stuehr, North Royalton, OH (US); John Gadus, Richfield, OH (US)

(73) Assignee: THE TIMKEN COMPANY, Canton, OH (US)

(21) Appl. No.: 13/878,607

(22) PCT Filed: Sep. 23, 2011
(86) PCT No.: PCT/US2011/053047

§ 371 Date: Apr. 10, 2013

Related U.S. Application Data
(60) Provisional application No. 61/391,816, filed on Oct. 11, 2010.

(51) Int. Cl. H05B 6/10

(52) U.S. Cl. CPC H05B 6/101
USPC 219/635; 219/672

(57) ABSTRACT

A method for heating surfaces includes heating the surface of a hole by inserting a magnet cylinder into the hole and rotating the magnet cylinder, heating the surface of a hole by inserting a magnet stack into the hole and reciprocating the magnet stack, or heating a selected area of a workpiece surface by positioning a magnet disc adjacent the selected area and rotating the magnet disc. In each case, eddy currents are produced, inducing heating of the surface.

### RELATED APPLICATIONS

This application claims the benefit of U.S. Provisional Patent Application No. 61/391,816, filed on Oct. 11, 2010, the entire content of which is hereby incorporated by reference.

### BACKGROUND

The heating of small holes, such as grease ports or holes in bearing components and the heating of selected surface areas of a workpiece is often necessary during the manufacturing of a product to impart desired properties to the product. Spot heating is sometimes required on a hard surface in order to maximize tooling life and improve the production rate. Spot heating is also used to help prevent, at great expense, carburizing.

The surfaces of small holes and selected areas of larger surfaces can be heated by induction heating. However, to heat a small hole, such as a grease port or hole on a bearing component, is extremely difficult to achieve via induction heating. The power to the inductor is limited due to the fact that a short may occur if the power is at a level sufficient enough to cause eddy currents to be induced from one side of the inductor into the other side. Induction heating of a selected area of a workpiece surface is possible with a coil designed such that the heating is localized within a given geometric area. In such an application, the heating results from eddy currents generated within the material. By also utilizing conduction, deeper heat penetration is obtained for a given frequency utilized. The power supplies required for induction, although low in power output, are costly.

Spot heating a selected area of a surface can also be accomplished by flame heating where the flames are directed by a nozzle. In flame heating, the material is heated by conduction which has a significantly slower heating rate as the thickness of the material increases. Flame heating requires a fuel source and can produce green house gases. Ventilation is required to ameliorate potential personnel safety issues.

### SUMMARY

Rotational Magnetic Heating (RMH) improves upon the prior art methods for spot heating and hole heating by using more economical and safer equipment. RMH is capable of more readily changing the frequency over a broader range as compared to conventional induction power supplies. Like induction heating, RMH produces eddy currents, however, without the need for a variable frequency power supply. RMH is safer and more environmentally friendly than flame heating. In carburizing, regions that will be machined post-heat treatment may be coated with paint to prevent carbon diffusion and remain soft. This paint must be manually applied, increasing cost.

RMH can be used for hardening, tempering or other heat treatment of the surface of a hole. To accomplish hole heating via RMH, magnets arranged as a cylinder and with their poles alternating can be placed within the hole and rotated by a drive. Due to their high strength-to-size ratio, the inner diameter of small holes can be heated, and thus heat treated. In spot heating, the magnets are arranged annularly and are rotated by a spindle above or adjacent the desired location.

By rotating the magnets at high rpm's, eddy currents are generated with ferromagnetic or paramagnetic materials placed in close proximity of the rotating magnets. The heat produced by the eddy currents is sufficient enough to anneal the material to a hardness suitable for machining For a constant heating time, the depth of penetration of the eddy currents is determined by the rotational speed of the spindle (and hence of the magnets). At lower rotational rates, a frequency suitable for deep penetration is produced; whereas at higher rotational rates, a frequency suitable for shallow penetration is produced.

As an alternative to RMH for heat treating the surface of a hole, a stack or lamination of magnets defining regions of alternating polarity can be reciprocated translationally or oscillated within a hole to generate eddy currents and harden, temper, or otherwise heat treat the surface of the hole.

### BRIEF DESCRIPTION OF THE DRAWINGS

FIG. 1 is a schematic drawing of a heating apparatus used for heating the surface of a hole;

FIGS. 2 and 3 are a schematic side elevational and plane views of a magnet cylinder of the device of FIG. 1, showing the orientation of the magnets of the magnet cylinder;

FIG. 4 is a schematic drawing of a heating apparatus used for heating a selected area of a workpiece surface;

FIG. 5 is a schematic plan view of a magnet disc for use with the device of FIG. 4, showing the orientation of the magnets of the magnet disc; and

FIGS. 6 and 7 are schematic section views of a magnet stack being reciprocated translationally to heat the surface of a hole.

Corresponding reference numerals will be used throughout the several figures of the drawings.

### DETAILED DESCRIPTION

The following detailed description illustrates the invention by way of example and not by way of limitation. This description will clearly enable one skilled in the art to make and use the invention, and describes several embodiments, adaptations, variations, alternatives and uses of the invention, including what I presently believe is the best mode of carrying out the invention. Additionally, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

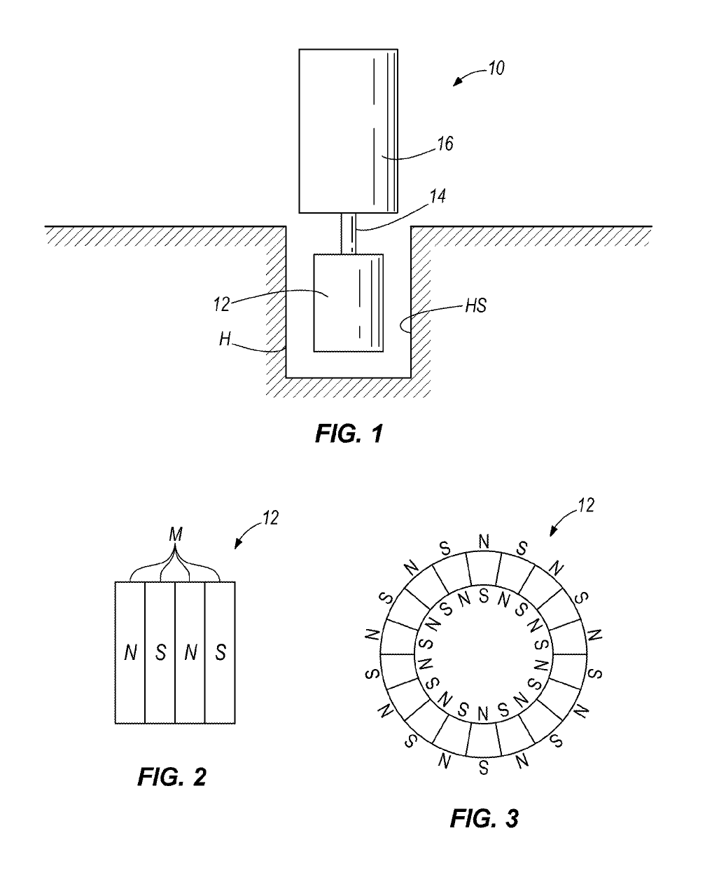

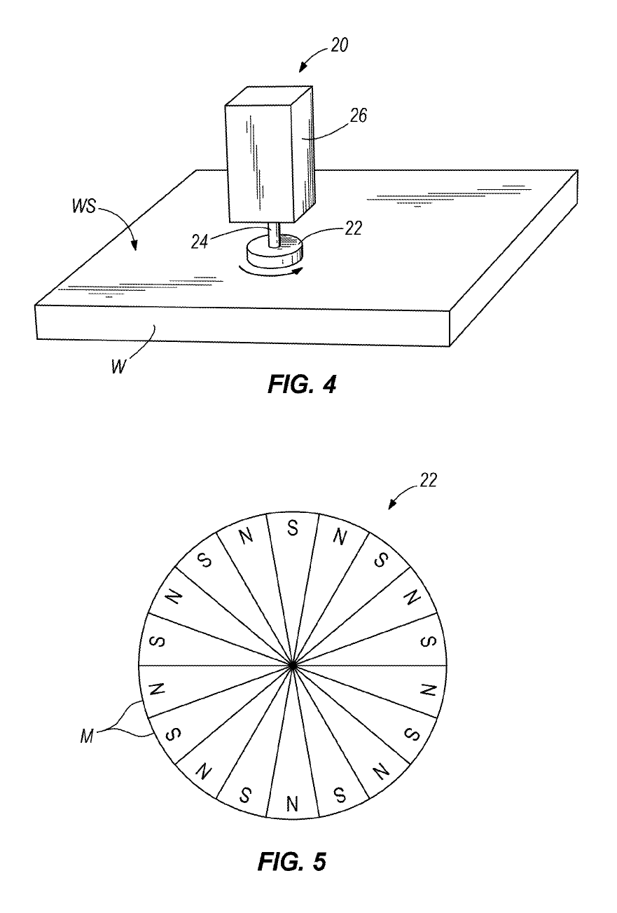

FIG. 1 schematically shows a heating device 10 that is used to heat the surface HS of a hole H. The heating device 10 comprises a magnet cylinder 12 mounted to the bottom of a shaft 14 which in turn is connected to a drive 16. The drive 16 can be an electric motor or any other type of drive which can impart rotational motion to the shaft 14 and the magnet cylinder 12. As shown in FIGS. 2 and 3, the magnet cylinder 12 is comprised of a plurality of elongate permanent magnets M, each of which has a north pole N and a south pole S. The magnets M are configured such that the pole sides of the magnets form a cylinder of a desired axial length, preferably, the magnets M have a length generally equal to the depth of the hole (or the depth to which the hole surface is to be heated). Further, the magnets M are positioned in the cylinder 12 such that the poles alternate, thereby defining regions of alternating polarity. Thus, as seen in FIG. 2, the side surface of the magnet cylinder 12 presents elongate magnet surfaces of alternating poles.

The magnets M are preferably rare earth permanent magnets capable of delivering a continuous flux density of greater than 1 Tesla. The illustrated embodiment uses neodymium-iron-boron (NdFeB) magnets of about 1.2 T and a Curie temperature of about 540 degrees Fahrenheit, however, other suitable rare earth magnets can also be used. In an alternative embodiment, ceramic magnets can be alternatingly positioned between every two NdFeB magnets. The orientation of the NdFeB magnets would be constant. The ceramic magnets can be electrically activated to create fields opposite in polarity to the NdFeB magnets. In other embodiments, the magnet cylinder 12 can be formed by starting with an unmagnetized cylinder of a desired size and shape and magnetizing it to have the desired magnetic characteristics (i.e., the desired regions of alternating polarity), such as those achieved by using the magnets M. As used herein an in the appended claims, the term “magnet cylinder” includes both a cylinder made from a plurality of individual magnets and a cylinder that is magnetized to have the desired magnetic characteristics.

FIG. 4 schematically shows a heating device 20 for heating a selected area of a surface WS of a workpiece W. The heating device 20 comprises a magnet disc 22 mounted to the bottom of a shaft 24 which in turn is connected to a drive 26. The drive 26 can be an electric motor or any other type of drive which can impart rotational motion to the shaft 24 and the magnet cylinder 22. As shown in FIG. 5, the magnet disc 22 is comprised of a plurality of elongate permanent magnets M, each of which has a north pole N and a south pole S. The magnets have a length sufficient to define a circle of a desired diameter. Smaller length magnets will produce smaller discs, and hence, will heat smaller areas than longer magnets. The magnets M are configured such that the pole sides of the magnets form a lower surface of the magnet disc 22. Further, the magnets M are positioned in the disc 22 such that the poles alternate, thereby defining regions of alternating polarity. Thus, as seen in FIG. 5, the bottom surface of the magnet disc 22 presents magnet surfaces which define the disc, the surface of adjacent magnets being of different poles. In other embodiments, the magnet disc 22 can be formed by starting with an unmagnetized disc of a desired size and shape and magnetizing it to have the desired magnetic characteristics (i.e., the desired regions of alternating polarity), such as those achieved by using the magnets M. As used herein an in the appended claims, the term “magnet disc” includes both a disc made from a plurality of individual magnets and a disc that is magnetized to have the desired magnetic characteristics.

In operation, to heat a hole surface HS, the magnet cylinder 12 has a diameter that is slightly less than the diameter of the hole, such that the hole surface HS will be within a magnetic field produced by the magnets M. Similarly, to spot heat an area of a workpiece surface WS, the magnet disc 22 is positioned proximate the area of the surface WS to be heated, with the bottom surface of the disc 22 facing the surface WS. The disc 22 is positioned such that there is a gap between the disc 22 and the workpiece surface WS, but such that the workpiece surface is within the magnetic field produced by the magnets M of the disc 22. In either device, the magnet cylinder 12 or disc 22 is rotated by the drive 16, 26. The rotation of the magnets M produces eddy currents which heat the surface HS, WS. For a given amount of heating time, the depth of penetration of the heating is dependent upon the frequency of the eddy currents. The frequency, in turn, is dependent upon the number of poles in the cylinder 12 or disc 22 and the rate of rotation of the cylinder 12 or disc 22.

The formula equating the frequency (Hz), the number of poles (nP), and the rotational rate (RPM) is set forth as Hz=(nP*RPM)/60. The factor of 60 is to convert the RPM to revolutions per second (RPS), producing a frequency similar to that of a current from a power supply. The frequency is directly proportional to the number of poles and the rotational rate. Therefore, if the rotational rate of the magnet cylinder 12 or magnet disk 22 is reduced, the same frequency can be achieved by increasing the number of poles.

In RMH, high magnetic flux frequency is generated even with low cost commodity industrial electric motors or other drive systems whose speed is often limited to a few thousands revolutions per minute. The rotation of the magnets M generates eddy currents within ferromagnetic or paramagnetic materials placed in close proximity to the tool piece. As the rotational speed increases, a progressively shallower region is heated. In the context of spot surface heating, the heat produced within the material by the eddy currents is sufficient enough to anneal the material to a hardness suitable for machining In some applications, the heating can be useful for hardening the surface of a hole or of a workpiece. Induced heating of the workpiece can be used to achieve a temperature in the austenitic range of the workpiece, resulting in hardening of the workpiece through a microstructural transformation after quenching. Such hardening could be useful in preserving threads or improving wear characteristics in the hole surface.

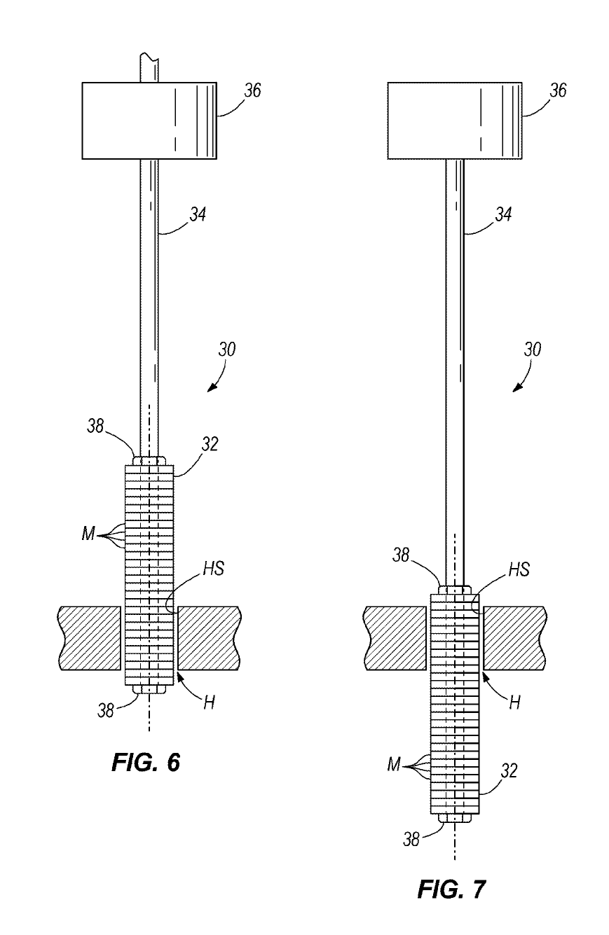

FIGS. 6 and 7 schematically illustrate a heating device 30 that is used to heat the surface HS of a hole H. The heating device 30 comprises a stack or lamination of permanent magnets 32 mounted on a shaft 34, which in turn is connected to a drive 36. The drive 36 can be a linear actuator (e.g., a solenoid, etc.) or any other type of drive (e.g., rack and pinion arrangement, cam/follower arrangement, etc.) which can impart translational reciprocating motion or oscillation to the shaft 34 and the magnet stack 32. As shown in FIGS. 6 and 7, the magnet stack 32 is comprised of a plurality of annular, disk-shaped permanent magnets M, each of which has a north pole N and a south pole S. The magnets M are configured such that a north pole of one magnet faces a north pole of an adjacent magnet in the magnet stack 32. Likewise, a south pole of one magnet faces a south pole of an adjacent magnet in the magnet stack 32. In other words, the magnetically opposing pole sides of the magnets face each other, resulting in regions of alternating polarity and resulting in the magnets M tending to repel one another. The magnets M are assembled in the magnet stack 32 using suitable securing means to hold the repelling magnets M together. In the illustrated embodiment, stop members 38 are provided to secure the magnets M together in the magnet stack 32 on the shaft 34 to form a cylinder of a desired axial length. In other embodiments, the magnet stack 32 can be formed by starting with an unmagnetized member or cylinder of a desired size and shape and magnetizing it to have the desired magnetic characteristics (i.e., the desired regions of alternating polarity), such as those achieved by using the magnets M. As used herein an in the appended claims, the term “magnet stack” includes both a stack made from a plurality of individual magnets and a stack that is magnetized to have the desired magnetic characteristics.

Preferably, the magnet stack 32 has an axial length greater than the depth of the through hole H (or the depth to which the hole surface is to be heated). As seen in FIGS. 6 and 7, the hole H is a through hole and the magnet stack 32 has an axial length greater than or equal to three times the depth of the through hole H. In other embodiments, the hole can be a blind bore that can be heat treated via oscillation of the magnet stack 32 so that at least an portion of the hole surface HS adjacent the open end of the hole can be heat treated.

In operation, to heat a hole surface HS using the heating device 30, the magnet stack 32 has an outer diameter that is slightly less than the diameter of the hole H, such that the hole surface HS will be within a magnetic field produced by the magnets M. The magnet stack 32 is translationally reciprocated or oscillated along the axis of the hole between the positions shown in FIGS. 6 and 7 by the drive 36. The reciprocating translation or oscillation of the magnets M produces eddy currents which heat the surface HS. For a given heating time, the depth of penetration of the heating is dependent upon the frequency of the eddy currents. The frequency, in turn, is dependent upon the number of poles and the rate of reciprocation or oscillation of the magnet stack 32. For a given amount of heating time, to heat to a deeper depth, a lower rate of reciprocation can be used, while a higher rate of reciprocation can be used to heat to a shallower depth.

In the embodiment illustrated in FIGS. 6 and 7, the hole H has a diameter of about 0.455 inches and the magnet stack 32 includes twenty-eight ring magnets M of grade N42. The ring magnets M have an outer diameter of about 0.375 inches, an inner diameter of about 0.125 inches, and a thickness of about 0.0625 inches. This results in eight cycles per one inch of travel of the magnet stack 32 in a single direction, and sixteen cycles for each stroke of one inch movement (both up and down). An exemplary rate of 3,000 strokes per minute would therefore result in 48,000 cycles per minute, or 800 cycles per second. In other embodiments, the particular ring magnets M, stroke travel, and reciprocation rate can vary to suit the particular application.

As various changes could be made in the above constructions without departing from the scope of the invention, it is intended that all matter contained in the above description or shown in the accompanying drawings shall be interpreted as illustrative and not in a limiting sense. Various features of the invention are set forth in the following claims.

1. A method for heating the surface of a hole, the method comprising:
inserting a magnet cylinder into the hole, the magnet cylinder defining regions of alternating polarity and having a diameter sized such that when received in the hole, a magnetic field of the magnet cylinder will extend to the surface of the hole; and
rotating the magnet cylinder at a desired rotational rate to produce eddy currents, the eddy currents inducing heating of the surface.

2. The method of claim 1, wherein the magnet cylinder is formed of a cylinder that has been magnetized to define the regions of alternating polarity.

3. The method of claim 1, wherein the magnet cylinder is comprised of a plurality of elongate magnets each having a north pole and a south pole, the magnets being configured such that pole sides of the magnets form a cylinder of a desired axial length, and wherein the magnets are positioned in the cylinder such that the poles alternate.

4. The method of claim 1, wherein the magnet cylinder has a length generally equal to the depth of the hole.

5. The method of claim 1, wherein the magnet cylinder has a length equal to the depth to which the hole surface is to be heated.

6. The method of claim 1, further comprising controlling a frequency of the eddy currents to control a depth to which said surface is heated.

7. The method of claim 6, wherein controlling the frequency of the eddy currents comprises selecting a number of poles for the magnet cylinder and rotating the magnet cylinder at a desired rate.

8. The method of claim 7, further comprising rotating the magnet cylinder at a high rotational rate to produce shallow heating and at a low rotational rate to produce deep heating of the surface.

9. A method for spot heating a selected area of a workpiece surface, the method comprising:
positioning a magnet disc adjacent said selected area, the magnet disc defining regions of alternating polarity and being positioned from the selected area a distance such that a magnetic field of the magnet disc extends to the area of the surface; and
rotating the magnet disc at a desired rotational rate to produce eddy currents, the eddy currents inducing heating of the surface.

10. The method of claim 9, wherein the magnet disc is formed of a disc that has been magnetized to define the regions of alternating polarity.

11. The method of claim 9, wherein the magnet disc is formed of a plurality of elongate permanent magnets, each of which has a north pole and a south pole, the magnets having a length sufficient to define a circle of a desired diameter, the magnets being configured such that pole sides of the magnets form a lower surface of the magnet disc, the magnets being positioned in the disc such that the poles alternate.

12. The method of claim 9, further including varying the rotational rate of said disc to control the depth of heating.

13. The method of claim 12, further comprising driving the disc at a lower rotational rate to heat a deeper depth of material and driving the disc at a higher rotational rate to heat a shallower depth of material.

14-23. (canceled)
